(19) United States
(12) Patent Application Publication
(10) Pub. No.: US 2007/0135135 A1
(43) Pub. Date: Jun. 14, 2007

(54) Electronic equipment with content management function and program for providing same

(76) Inventor: Kenneth Brown, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/298,790

(22) Filed: Dec. 9, 2005

(51) Int. Cl. H04Q 7/20

(52) U.S. Cl. 455/456.1

(57) ABSTRACT

A method and program for managing content in a portable electronic equipment with wireless communication capability and having a memory for storing content are disclosed. Content management may include receiving content and storing the content in a memory. The content may be related to a particular location and received/transmitted upon positioning of the portable electronic equipment in or near the particular location. Such content may have a lifespan related to departure of the portable electronic equipment from the location. Furthermore, the content may have a temporal based lifespan, which may be unrelated to any location based lifespan. The content may be deleted upon expiration of the location based lifespan or the temporal based lifespan.

### TECHNICAL FIELD OF THE INVENTION

The present invention relates generally to electronic equipment for engaging in voice communications and, more particularly to electronic equipment that includes a content management function to conserve memory resources.

### DESCRIPTION OF THE RELATED ART

Electronic equipment that provide for voice communication are becoming increasingly popular. In addition, the features associated with the electronic equipment have become increasingly diverse. To name a few examples, many electronic equipment include cameras, Internet browsing functionality, video playback capability, audio playback capability, image display capability and hands-free headset interfaces.

The electronic equipment can include a memory used to store data, address book or contact information, ring tones, video clips, audio clips, image files and so forth. These items and any other types of items stored by the memory are typically arranged in files and will be referred to herein as content. The memory is typically of limited capacity. Once the capacity of the memory is reached, additional content cannot be stored by the electronic equipment. Furthermore, once stored, such content is retained by the memory until the user deletes the content from the memory.

In some communications networks or systems, content may be transmitted to the electronic equipment from a server or other device for storage by the memory. Delivering content may involve an act by the user of the electronic equipment to download, transfer or accept the content. Alternatively, content may be pushed to or pulled by the electronic equipment without user action or with minimal user action. Content also may be attached or otherwise included with a text message, an electronic mail message, a voice message or other transmission received by the electronic equipment.

As can be appreciated, the memory of the electronic equipment may become consumed by stored content. In such cases, performance of the electronic equipment may be degraded and/or the user may loose the ability to store additional content unless remedial action is taken.

### SUMMARY

In view of the aforementioned shortcomings associated with existing electronic equipment that are subject to memory capacity issues, there is a need in the art for electronic equipment that does not suffer from such drawbacks. More particularly, there is a need in the art for electronic equipment that includes a content management function.

According to one aspect of the invention, a method of managing content in a portable electronic equipment with wireless communication capability and having a memory for storing content includes receiving content related to a particular location upon positioning of the portable electronic equipment in or near the particular location from a source configured to transmit the location related content as a function of the position of the mobile radio terminal with respect to the location; and storing the location related content in the memory.

In a preferred embodiment, the method further includes deleting the location related content upon departure of the portable electronic equipment from the location.

According to another aspect of the invention, a method of managing content for a portable electronic equipment with wireless communication capability and having a memory for storing content includes detecting that the portable electronic equipment is in or near a particular location; and transmitting content related to the particular location to the portable electronic equipment upon the detecting.

In a preferred embodiment, the method further includes determining if the portable electronic equipment is a subscriber for the location related content or is configured to accept the location related content before transmitting.

According to another aspect of the invention, a method of managing content in a portable electronic equipment having wireless communication capability and having a memory for storing content includes receiving content having a temporal based lifespan; storing the content in the memory; and deleting the content upon expiration of the temporal based lifespan.

According to yet another aspect of the invention, a program stored on a machine usable medium, the program including a content management function for a portable electronic equipment with wireless communication capability and having a memory for storing content and executable logic to receive content related to a particular location upon positioning of the portable electronic equipment in or near the particular location from a source configured to transmit the location related content as a function of the position of the mobile radio terminal with respect to the location; and store the location related content in the memory.

According to still another aspect of the invention, a program stored on a machine usable medium, the program including a content management function for a portable electronic equipment with wireless communication capability and having a memory for storing content and executable logic to detect that the portable electronic equipment is in or near a particular location; and transmit content related to the particular location to the portable electronic equipment upon the detecting.

According to another aspect of the invention, a program stored on a machine usable medium, the program including a content management function for a portable electronic equipment with wireless communication capability and having a memory for storing content and executable logic to receive content having a temporal based lifespan; store the content in the memory; and delete the content upon expiration of the temporal based lifespan.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic view of a mobile telephone as an exemplary electronic equipment in accordance with an embodiment of the present invention;

FIG. 2 is a schematic block diagram of the relevant portions of the mobile telephone of FIG. 1 in accordance with an embodiment of the present invention;

FIG. 3 is a schematic block diagram of a system in which the mobile telephone can communicate as an exemplary communications system in accordance with an embodiment of the present invention;

FIG. 4 is a flow chart of an exemplary content management scheme carried out by the mobile telephone in accordance with an embodiment of the present invention;

FIG. 5 is a flow chart of an exemplary content management scheme carried out by system components of the communications system in accordance with an embodiment of the present invention;

FIG. 6 is a diagram showing an exemplary content management scheme carried out by system components of the communications system in accordance with an embodiment of the present invention;

FIG. 7 is a diagram showing another exemplary content management scheme carried out by system components of the communications system in accordance with an embodiment of the present invention;

FIG. 8 is a diagram showing another exemplary content management scheme carried out by system components of the communications system in accordance with an embodiment of the present invention; and

FIG. 9 is a flow chart of another exemplary content management scheme carried out by the mobile telephone in accordance with an embodiment of the present invention.

### DETAILED DESCRIPTION OF EMBODIMENTS

The present invention will now be described with reference to the drawings, wherein like reference numerals are used to refer to like elements throughout.

The term “electronic equipment” includes portable radio communication equipment. The term “portable radio communication equipment,” which herein after is referred to as a “mobile radio terminal,” includes all equipment such as mobile telephones, pagers, communicators, i.e., electronic organizers, personal digital assistants (PDAs), smartphones, portable communication apparatus or the like.

In the present application, the invention is described primarily in the context of a mobile telephone. However, it will be appreciated that the invention is not intended to be limited to a mobile telephone and can be any type of electronic equipment.

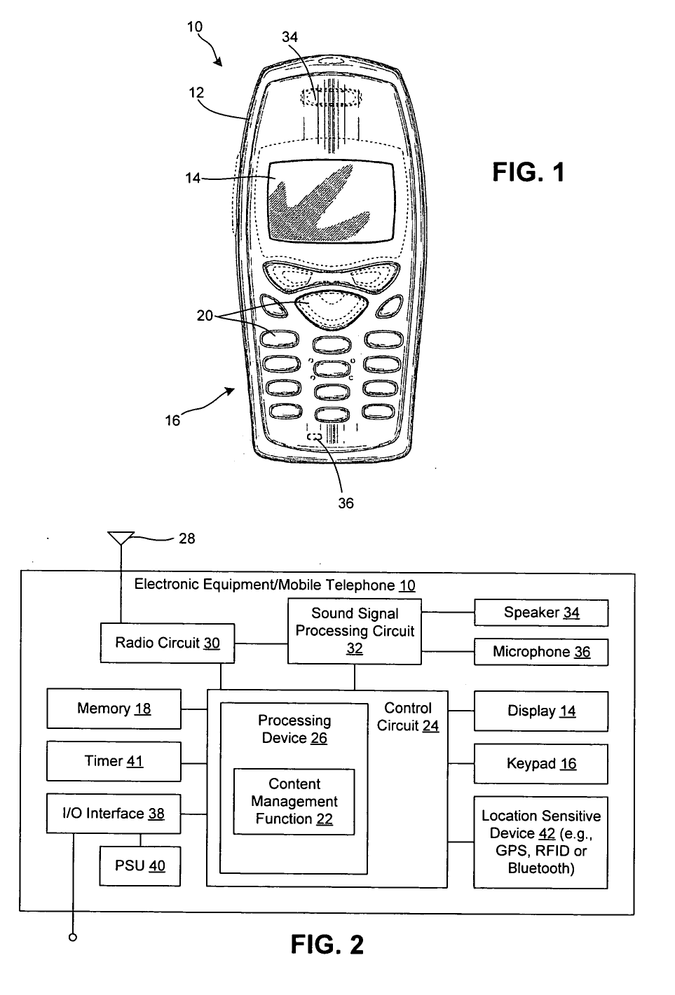

Referring initially to FIG. 1, an electronic equipment 10 is shown in accordance with the present invention. The electronic equipment includes a content management function that is configured to delete content from a memory of the electronic equipment 10 upon the occurrence of a predetermined event. Predetermined events can include, for example, the movement of the electronic equipment 10 out of a specified location and/or the expiration of a lifespan of the content.

In the exemplary embodiment described herein, the electronic equipment is a mobile telephone and will be referred to as the mobile telephone 10. The mobile telephone 10 is shown as having a “brick” or “block” design type housing 12, but it will be appreciated that other type housings, such as a clamshell housing or a slide-type housing, may be utilized without departing from the scope of the invention.

The mobile telephone 10 includes a display 14 and keypad 16. As is conventional, the display 14 displays information to a user such as operating state, time, telephone numbers, contact information, various navigational menus, etc., which enable the user to utilize the various feature of the mobile telephone 10. The display 14 may also be used to visually display content received by the mobile telephone 10 and/or retrieved from a memory 18 (FIG. 2) of the mobile telephone 10.

Similarly, the keypad 16 may be conventional in that it provides for a variety of user input operations. For example, the keypad 16 typically includes alphanumeric keys 20 for allowing entry of alphanumeric information such as telephone numbers, phone lists, contact information, notes, etc. In addition, the keypad 16 typically includes special function keys such as a “call send” key for initiating or answering a call, and a “call end” key for ending, or “hanging up” a call. Special function keys may also include menu navigation keys, for example, for navigating through a menu displayed on the display 14 to select different telephone functions, profiles, settings, etc., as is conventional. Other keys associated with the mobile telephone may include a volume key, audio mute key, an on/off power key, a web browser launch key, a camera key, etc. Keys or key-like functionality may also be embodied as a touch screen associated with the display 14.

As will become more apparent in view of the following description, the mobile telephone 10 overcomes the aforementioned shortcomings associated with existing electronic equipment. Specifically, the mobile telephone 10 includes conventional call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc.

FIG. 2 represents a functional block diagram of the mobile telephone 10. With the exception of a content management function 22 according to the present invention, which is preferably implemented as executable logic in the form of application software or code within the mobile telephone 10, the construction of the mobile telephone 10 is otherwise generally conventional. The mobile telephone 10 includes a primary control circuit 24 that is configured to carry out overall control of the functions and operations of the mobile telephone 10. The control circuit 24 may include a processing device 26, such as a CPU, microcontroller or microprocessor. The processing device 26 executes code stored in a memory within the control circuit 24 (not shown) and/or in a separate memory, such as memory 18, in order to carry out conventional operation of the mobile telephone 10. The memory 18 can be, for example, a flash memory, a hard drive, a removable media, a volatile memory and/or a non-volatile memory. In addition, the processing device 26 executes code in accordance with the present invention in order to perform the content management function 22.

It will be apparent to a person having ordinary skill in the art of computer programming, and specifically in applications programming for mobile telephones, how to program a mobile telephone 10 to operate and carry out the functions described herein. Accordingly, details as to the specific programming code have been left out for sake of brevity. Also, while the content management function 22 is executed by the processing device 26 in accordance with the preferred embodiment of the invention, such functionality could also be carried out via dedicated hardware, firmware, software, or combinations thereof, without departing from the scope of the invention. In addition, corresponding functions of a server and/or proximity detector that interact with mobile telephone 10 can be embodied as executable logic that is stored by a memory of those devices and/or executed by a processor of those devices.

Continuing to refer to FIGS. 1 and 2, the mobile telephone 10 includes an antenna 28 coupled to a radio circuit 30. The radio circuit 30 includes a radio frequency transmitter and receiver for transmitting and receiving signals via the antenna 28 as is conventional. The mobile telephone 10 further includes a sound signal processing circuit 32 for processing the audio signal transmitted by/received from the radio circuit 28. Coupled to the sound processing circuit 32 are a speaker 34 and a microphone 36 that enable a user to listen and speak via the mobile telephone 10 as is conventional. The radio circuit 30 and sound processing circuit 32 are each coupled to the control circuit 24 so as to carry out overall operation.

The mobile telephone 10 also includes the aforementioned display 14 and keypad 16 coupled to the control circuit 24. The mobile telephone 10 further includes an I/O interface 38. The I/O interface 38 may be in the form of typical mobile telephone I/O interfaces, such as a multi-element connector at the base of the mobile telephone 10. As is typical, the I/O interface 38 may be used to couple the mobile telephone 10 to a battery charger to charge a power supply unit 40 within the mobile telephone 10. In addition, or in the alternative, the I/O interface 38 may serve to connect the mobile telephone 10 to a wired personal hands-free adaptor (not shown) or a local wireless interface (e.g., a Bluetooth adaptor (not shown) for use with a Bluetooth-based hands-free adaptor). Further, the I/O interface 38 may serve to connect the mobile telephone 10 to a personal computer or other device via a data cable, etc.

The I/O interface 38 is not necessary to the fundamental aspects of the present invention. Nor are the particular functions of the I/O interface 38 necessarily germane to the invention. On the other hand, according to one particular aspect of the invention, the control circuit 24 is configured to automatically detect when a wired or wireless (e.g., Bluetooth) device is in communication with the mobile telephone 10. This may be via mechanical contact, device ID detection, etc. Such feature is known in mobile telephones. However, as described in more detail below, the present invention may make use of such a feature in conjunction with its content management function 22.

The mobile telephone 10 may also include a timer 41 for carrying out timing functions. Such functions may include timing the durations of calls, etc. In addition, the timer 41 may serve to detect such things as a lifespan expiration for content stored by the memory 18 as will be explained in more detail below.

The mobile telephone 10 may include a location sensitive device 42. In one exemplary embodiment, the location sensitive device 42 is a global positioning receiver configured to receive position data from a global positioning satellite (GPS) and to pass the position data (e.g., in terms of longitude and latitude) to the control circuit 24. From this information, the position of the mobile telephone 10 relative to a particular location (e.g., a building, city block, stadium, retail store, etc.) can be determined. In another exemplary embodiment, the location sensitive device 42 can be a radio frequency identification (RFID) tag or transponder. In this embodiment, if the mobile telephone 10 were to come within the operable range of an RFID reader (not shown), the presence or absence of the mobile telephone 10 can be determined based on a reply signal broadcast by the location sensitive device 42. The receipt of the reply signal can be used as an indication of the relative location of the mobile telephone 10 to the particular location. In yet another exemplary embodiment, the location sensitive device 42 can be local wireless adapter, such as a Bluetooth adapter, which may be physically associated with the I/O interface 38 instead of a separate component. In this embodiment, if the mobile telephone 10 were to come within the operable range of a corresponding wireless adapter, the presence or absence of the mobile telephone 10 can be determined based on an interface established by the wireless adapter of the mobile telephone 10 and the corresponding wireless adapter. The establishment of the interface can be used as an indication of the relative location of the mobile telephone 10 to the particular location.

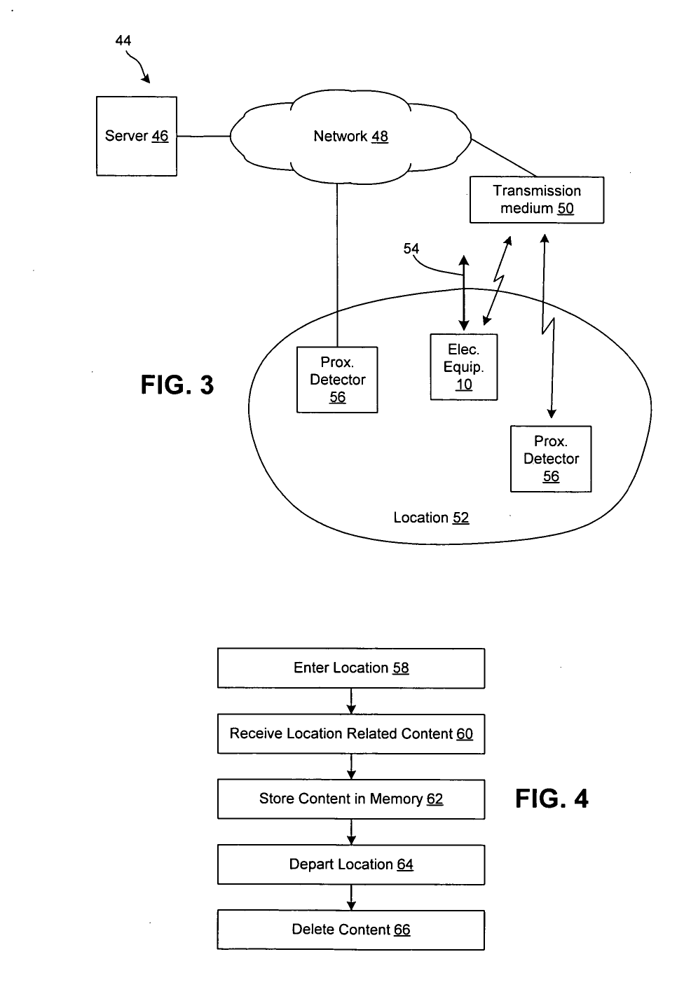

With additional reference to FIG. 3, represented is an exemplary communications system 44 in which the mobile telephone 10 can operate. The system 44 can include a server 46. In one embodiment, the server 46 can include a processor that executes logic to track the relative position of the mobile telephone 10, transmit content to the mobile telephone 10 and/or carry out functions complimentary to the content management function 22 of the mobile telephone 10. A function of the server 46 is to transmit content to the mobile telephone 10 and, as such, can be a computing device that services multiple mobile telephones 10, a dedicated device for transmitting specific types of content to mobile telephones 10, another electronic equipment (e.g., another mobile telephone 10) or any other suitable device.

In the illustrated embodiment, the server 46 communicates with the mobile telephone 10 via a network 48 and a transmission medium 50. The transmission medium 50 can be any appropriate device or assembly, including, for example, a communications tower, another mobile telephone, a wireless access point, a satellite, etc. Portions of the network 48 may include wireless transmission pathways.

As is apparent, the mobile telephone 10 is portable and can be carried into or out of a particular location 52. For purposes of this application, the location 52 is any point, place or area, and a departure from the location 52 will trigger the content management function 22 to delete content from the memory 18 that has an expiration associated with the location 52. By way of example, the location 52 can be a building, a city block, a sports stadium or arena, a performance venue, a retail store, a shopping mall, a workplace, an airport, a park, or any other place. Movement of the mobile telephone 10 into or out of the location 52 is indicated by arrow 54.

Associated with the location 52 can be one or more proximity detectors 56 that can be strategically placed to determine when the mobile telephone 10 is in or near the location 52. In one embodiment, the proximity detector(s) 56 is an RFID reader for detecting an RFID transponder of the mobile telephone 52. In another embodiment, the proximity detector(s) 56 is a wireless adapter (e.g., Bluetooth adapter) for establishing an interface with a compatible adapter of the mobile telephone 10. In other embodiments, the proximity detector 56 can be omitted from the system 44. For instance, the position of the mobile telephone 10 could be monitored by the server and/or the mobile telephone 10 using GPS signals or by an interface with the transmission medium 50.

Depending on the implementation of the system 44, the proximity detector(s) 56 could communicate with the server 46 directly, via the network 48, via the transmission medium 50 and/or via the mobile telephone 10. In other embodiment, the proximity detector(s) 56 communicates with the server 46 and the mobile telephone 10 to carry out features of the content management function 22 or communicates only with the mobile telephone 10.

In some embodiments, the server 46 can be a remote server, such as a server provided by a commercial mobile telephone service provider. In other embodiments, the server 46 can be associated with the location 52. In this case, and if the location 52 includes a proximity detector 56, the server 46 can be separate from, interfaced with or combined with the proximity detector 56. The server 46 and/or the proximity detector 56 may be physically present at the location 52 or at corn other location.

Variations to the illustrated system 44 configuration will be or become apparent to one of ordinary skill in the art based on the description herein. Each variation of the system 44 is intended to fall within the scope of the claims appended hereto.

Referring to FIG. 4, a position-based method of content management carried out by the mobile telephone 10 is depicted. The method can be embodied as executable code, such as in the form of the content management function 22.

The method starts in block 58 where the mobile telephone 10 enters the location 52 or becomes close enough to the location 52 to be detected as being present at the location 52. Then, in block 60, the mobile telephone 10 receives content related to the location 52. In block 62, the received content is stored by the memory 18. The location related content can be in any appropriate form, such as a data file, an audio file, a ring tone, a video file, an image file, an executable file or the like. The location related content can be pushed to or pulled by the mobile telephone 10, downloaded by user action or received by any other suitable technique. The source of the content can be any suitable device, including the server 46, another item of electronic equipment (e.g., another mobile telephone), the proximity detector 56, etc.

The nature of the content can be any type of content suitable for the location. An exemplary type of content is an advertisement for a particular product or service. For example, if the mobile telephone 10 is detected as entering a store that sells music, the content can include a sample of a newly released song. In this case, the location can be as general as the entire store, as specific as a music department of the store or as specific as a particular section of the music department. Another form of advertising may be a coupon. For instance, if the user were to enter the cereal aisle of a grocery store, an electronic coupon could be received for a particular brand of cereal.

Another exemplary type of content is a map or floor plan of the location or directions for traversing the location. For instance, if the user enters a building and would like directional information, content can be received and stored to assist the user. This type of content could be helpful, for example, when attempting to find seats at a sporting or performing arts event, a particular doctor's office in a hospital, a particular store in a mall, a particular item or area of interest in a museum, a particular point of interest in an airport, etc.

Combinations of location related information could be received. For instance, at a sporting event, the content could guide the user to a concession stand where the content could present the user with a coupon for an item sold at that concession stand.

At some point after the content is stored in the memory 18, the mobile telephone 10 may depart the location 52 as depicted in block 64. Upon departure of the mobile telephone 22 from the location 52, the process can proceed to block 66 where the content is deleted. As used herein, the act of deleting can include erasing the content from the memory 18 as is appropriate for the hardware that implements the memory 18. For this purpose, the content may be associated with an location based expiration semaphore (e.g., flag or trigger). The content management function 22 could be configured to recognize the expiration semaphore and delete the content when the mobile telephone 10 is no longer present in or near the location 52. In this manner, the content has a lifespan dependent on the position of the mobile telephone 10 relative to the location 52. Various ways in which the mobile telephone 10 could be configured to ascertain the position of the mobile telephone 10 relative to the location 52 are described below. Briefly, these techniques include a self awareness of a departure from the location 52 (e.g., by using GPS signals or the loss of a wireless interface) or the receipt of a departure signal from the server 46 or proximity detector 56.

As will be appreciated, the location related content can have utility to the user of the mobile telephone 10 when present in or near the location 52, but can have reduced or no utility after having departed from the location 52. Accordingly, provided is a system and method of managing the content to conserve memory 18 capacity by preserving content when the content may be useful to the user and deleting content that has diminished utility as a function of the position of the mobile telephone 10.

In one embodiment, the content can be deleted automatically upon detection of the departure from the location 52. In another embodiment, the user can be prompted to confirm that deletion of the content is desired. In addition, some content can be configured for automatic deletion while other content can be configured to require user confirmation before deletion.

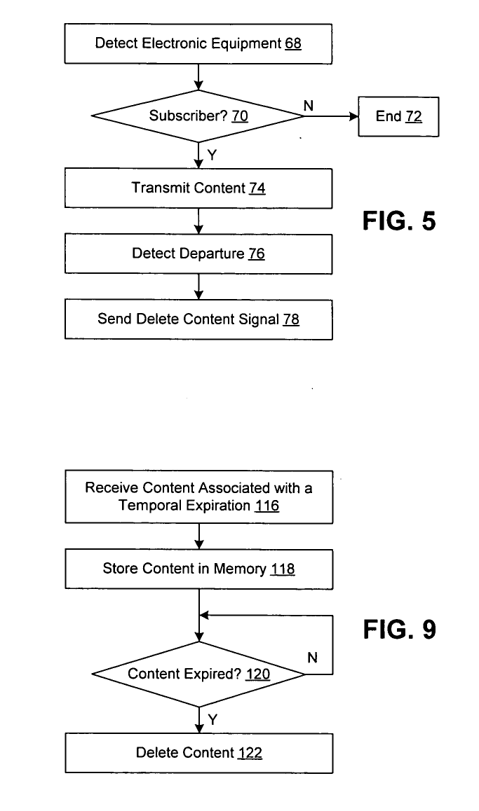

With reference to FIG. 5, a method of content management carried out by the server 46 and/or proximity detector 56 is depicted. The method can be embodied as executable code, such as in the form of a content management support function.

The method can start in block 68 where the presence of the mobile telephone 10 with respect to the location 52 is detected. Example manners in which the presence of the mobile telephone 10 in or near the location 52 are discussed below, and include, for example, sensing the mobile telephone 10 (e.g., by receipt of an RF signal from an RFID transponder of the mobile telephone 10 or by establishment of a wireless interface with the mobile telephone 10) or by information supplied by the mobile telephone 10 (e.g., GPS data received by the mobile telephone 10 and relayed to the server 46).

Next, in block 70, the process can determine if the mobile telephone 10 subscribes to a service for receiving location related content or has otherwise enabled the mobile telephone 10 to receive location related content. Checking to determine if the mobile telephone 10 is configured to receive location related content can reduce the transmission of content to the mobile telephone 10 of a user that does not wish to receive such content.

If, in block 70, a negative determination is made, the method can end in block 72. Otherwise, the process can proceed to block 74 where the location related content is transmitted from the server 46 to the mobile telephone 10. In one embodiment, if the mobile telephone 10 is to receive the content, the content can be automatically push delivered, pulled, retrieved or downloaded. In other embodiments, the user can be prompted to accept the content before transmission or following receipt. In other embodiments, the server 46 is not configured to determine if the mobile telephone 10 is to receive content in block 70, in which case the process can proceed from block 68 directly to block 74.

At some point after transmission of the location related content to the mobile telephone 10, the departure of the mobile telephone 10 from the location 52 can be detected. Various ways in which the server 46 could be configured to ascertain the position of the mobile telephone 10 relative to the location 52 are described below. Briefly, these techniques include a self awareness of a departure from the location 52 (e.g., the loss of a wireless interface or RFID signal) or the receipt of a location indicative signal from the mobile telephone 10 (e.g., a signal containing GPS information).

Since the mobile telephone 10 may be unaware of the relative position of the mobile telephone 10 with respect to the location 52, the process can proceed to block 78 where the server 46 transmits a signal to the mobile telephone 10 containing a command to delete the location related content. In one embodiment, upon receipt of such a signal, the content can be deleted automatically by the content management function 22 of the mobile telephone 10. In another embodiment, the user can be prompted to confirm that deletion of the content is desired. In addition, some content can be configured for automatic deletion while other content can be configured to require user confirmation before deletion.

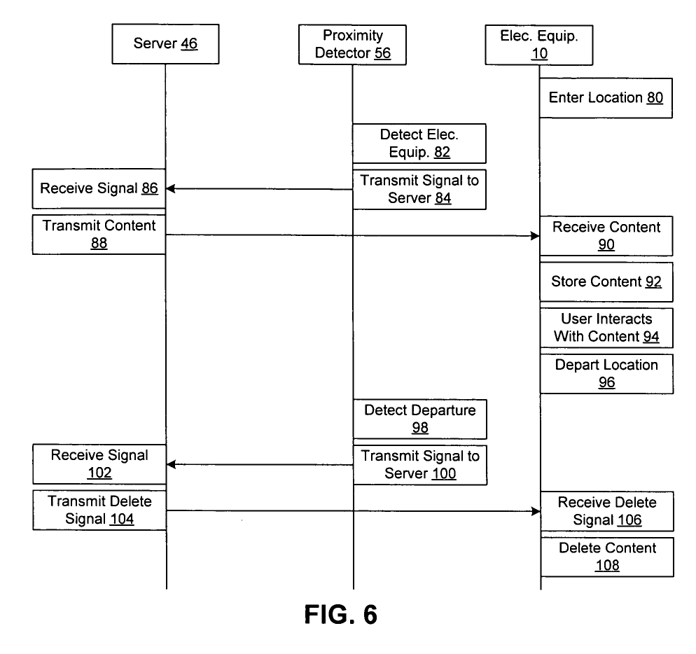

FIGS. 6-8 show some exemplary implementation schemes for transmitting and managing location related content carried out by various components of the system 44. Other implementation schemes and modifications to the illustrated and described implementations schemes are possible, each of which are intended to fall within the scope of the claims appended hereto.

In FIG. 6, when the mobile telephone 10 enters or nears the location 52 (block 80), the proximity detector 56 detects the arrival or presence of the mobile telephone 10 (block 82). Detection of the arrival or presence can be made by receiving an RFID signal from the mobile telephone 10, establishing a wireless interface with the mobile telephone 10 (e.g., using a local adapter such as Bluetooth or a wider area adapter such as the transmission medium 50 of FIG. 3), receiving GPS data regarding the position of the mobile telephone 10, user registration at a terminal present at the location 52, temporarily connecting the mobile telephone 10 to a docking port present at the location 52 or any other suitable technique.

Upon detection of the mobile telephone 10, the proximity sensor 56 transmits a signal to the server 46 indicating that the mobile telephone 10 is present in or near the location 52 (block 84). Upon receipt of such a signal (block 86) and any other appropriate data exchange between the server 46 and the mobile telephone 10, the server 46 transmits the location related content to the mobile telephone (block 88). The mobile telephone 10 then receives the content (block 90) and stores the content in the memory 18 (block 92). Storing the content can include any appropriate memory writing technique as is appropriate for the particular type of memory 18 of the mobile telephone 10.

Once stored, the user may or may not interact with the content (block 94). For example, if the content is an image file, the user may display the image file on the display 14 (FIGS. 1 and 2). As another example, if the content is a ring tone, the user may playback the ring tone through the speaker 34 (FIGS. 1 and 2). Once received and/or stored by the mobile telephone 10, the content may be played back, displayed, executed or otherwise acted upon with or without user action.

Once the user departs or become absent from the location (block 96), the departure or absence can be detected by the proximity detector 56 (block 98). Detection of the departure can be made by the absence of an RFID signal from the mobile telephone 10, the receipt of an RFID signal at an exit of the location 52, the loss of a wireless interface with the mobile telephone 10, receiving GPS data regarding the position of the mobile telephone 10, user log-off at a terminal present at the location 52, disconnection of the mobile telephone 10 from a docking port present at the location 52 or any other suitable technique.

Upon detection of the departure of the mobile telephone 10, the proximity sensor 56 transmits a signal to the server 46 indicating that the mobile telephone 10 is not in or near the location 52 (block 100). Upon receipt of such a signal (block 102) and any other appropriate data exchange between the server 46 and the mobile telephone 10, the server 46 transmits a signal (e.g., command) to the mobile telephone 10 indicating to the content management function 22 to delete the content (block 104). The signal is received by the mobile telephone 110 (block 106), at which point the content management function 22 deletes the content (block 108). As indicated, deletion of the content can be carried out after user authorization, if appropriate.

Provisions can be made for instances where the mobile telephone 10 is turned off or losses operating power between blocks 92 and 106, in which case the mobile telephone will not receive the signal to delete the content. For example, the content may be associated with a time based lifespan, after which the content management function deletes the content. Alternatively, when the mobile telephone 10 is returned to operation, the content management function 22 can force the mobile telephone 10 to interact with the server 46 and/or attempt to interact with the proximity detector 56 to reestablish the position of the mobile telephone 10 relative to the location 52. If such interaction with the server 46 and/or proximity detector 56 is not possible or indicates that the mobile telephone 10 is no longer in or near the location 52, the content management function 22 can delete the content.

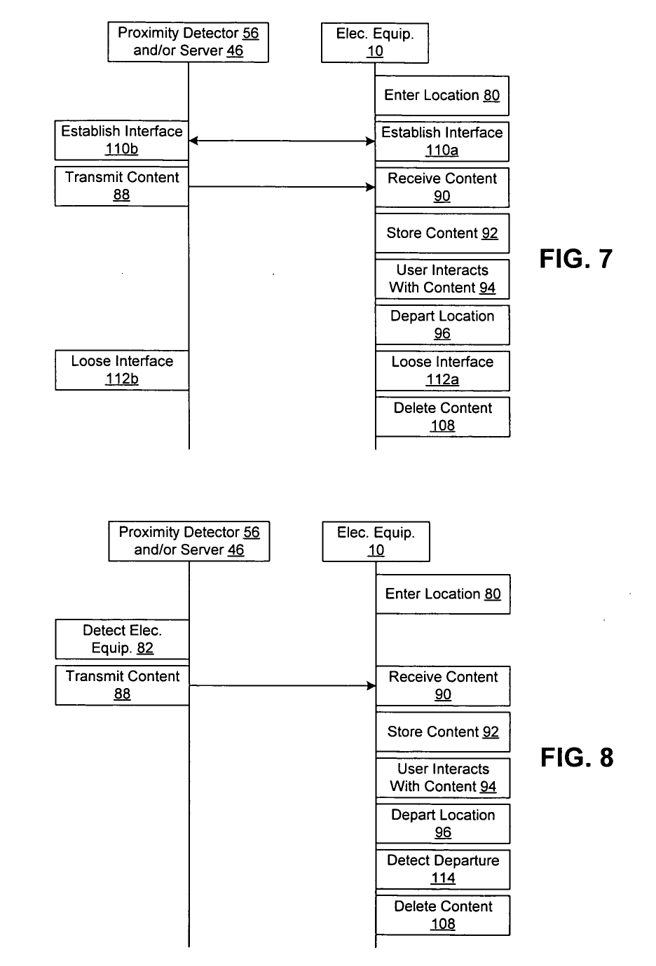

In the embodiment of FIG. 6, the mobile telephone 10 receives a signal to delete the content. In the embodiments of FIGS. 7 and 8, the content management function 22 of the mobile telephone 10 makes a determination as to when to delete the content. For the sake of brevity, operational details of blocks in FIGS. 7 and 8 that are the same as or very similar to blocks in FIG. 6 will be not be described in great detail and will be given the same reference numeral as the corresponding block in FIG. 6.

In FIG. 7, when the mobile telephone 10 enters or nears the location 52 (block 80), the mobile telephone 10 establishes an interface with the proximity detector 56 and/or server 46 (blocks 110a and 110b). The interface can be a local wireless interface (e.g., a Bluetooth interface with a local adapter), an interface with a mobile telephone service provider that operates the transmission medium 50 and transmits mobile telephone 10 position information to the server 46, the connecting of the mobile telephone 10 to a docking port, any other suitable interface establishment scheme.

Then, the server 46 transmits the location related content to the mobile telephone (block 88). The mobile telephone 10 then receives the content (block 90) and stores the content in the memory 18 (block 92). Once stored, the user may or may not interact with the content (block 94).

Once the user departs or becomes absent from the location (block 96), the interface with the proximity detector 56 and/or server 46 becomes lost (blocks 112a and 112b). At this point, the content management function 22 can delete the content (block 108). As indicated, deletion of the content can be carried out after user authorization, if appropriate.

In FIG. 8, when the mobile telephone 10 enters or nears the location 52 (block 80), the presence of the mobile telephone 10 is detected by the proximity detector 56 and/or server 46 (block 82) by any of the foregoing techniques or other suitable technique, including the automatic detection of the mobile telephone 10, the receipt of location indicating data or a request for location related content by the mobile telephone 10. Then, the server 46 transmits the location related content to the mobile telephone (block 88). The mobile telephone 10 then receives the content (block 90) and stores the content in the memory 18 (block 92). Once stored, the user may or may not interact with the content (block 94).

Once the user departs or become absent from the location (block 96), the content management function 22 can detect that the mobile telephone 10 has left the location 52 (block 114) and delete the content (block 108). As indicated, deletion of the content can be carried out after user authorization, if appropriate.

Detecting the departure (block 114) can be accomplished in any suitable manner. In one embodiment, the user can interact with the mobile telephone 10 to indicate that the mobile telephone 10 has a new position not associated with the location 52. If the user does not enter such information on their own accord after a predetermined period of time after the content was received, the content management function 22 can prompt the user to indicate if the user is still located at the location 52 or has left. If user action indicates that the mobile telephone 10 has left the location 52, the content management function 22 can delete the content (block 108).

In another embodiment, the content management function 22 can track the position of the mobile telephone 10 relative to the location 52. For example, the received content can include position data associated with the location 52 or the position of the mobile telephone 10 at the time of transmission from the server 46. Alternatively, the mobile telephone 10 may log the position of the mobile telephone 10 at the time of receiving the content (e.g., from GPS data). As the mobile telephone 10 moves, the mobile telephone 10 may receive GPS data or other position indicative information from the proximity detector 56, server 46 or transmission medium 50. The content management function 22 can compare the location information associated with the content to current position information and when the two are sufficiently far enough apart, the content management function 22 can delete the content (block 108).

In yet another embodiment where the mobile telephone 10 is serviced by a transmission medium 50 (FIG. 3) having a discemable range (e.g., a cell phone tower), the content management function 22 can be configured to detect when the mobile telephone 10 is no longer serviced by the transmission medium 50 through which the mobile telephone 10 received the content. For instance, the content may be received through a first transmission medium 50 having a range that covers the location 52. As long as the mobile telephone 10 continues to be serviced by the first transmission medium 50 it may be assumed that the mobile telephone 10 is at or sufficiently close to the location 52 to retain the content in the memory 18. When the mobile telephone 10 moves out of the range of the first transmission medium 50 and/or into the range of a second transmission medium 50 (e.g., invoking a handoff from the first transmission medium 50 to the second), it can be assumed that the mobile telephone 10 is no longer at or sufficiently close to the location 52 to continue to retain the content in the memory 18. At this point, the content can be deleted.

As used herein, the term deleting content explicitly includes updating and/or replacing the content. In one embodiment, the location related content can have a relationship to the new content that updates or replaces the “older” location related content. For example, if the content were the floor-plan of a first floor of a department store and the user were to move to a second floor of the department store, pushed to (or pulled by) the mobile telephone 10 could be the a floor-plan for the second floor. The second floor floor-plan could replace the first floor floor-plan by, for example, deleting the first floor floor-plan in whole or in part and storing the second floor floor-plan in whole or in part. Alternatively, an updated floor-plan having information related to both floors could be stored. Accordingly, deleting the location related content may be based on departure from one location and arrival at another location.

As another example, in a museum, as the user moves the mobile telephone 10 from one display to another, the location related content can be updated to be related to the display currently having a relationship to the position of the mobile telephone 10. Such content could include music, text, video, an audio description, etc. As the user moves from place to place within the museum or exhibit, the content could be replaced incrementally based on location. As such, the content transmitted to the mobile telephone 10 could function as a guided tour through the museum or exhibit.

In one embodiment, content to update and/or replace existing location related content may be requested by the mobile telephone 10 based on the content currently stored. The request may be automatically generated if the mobile telephone 10 senses movement from one position to another or based on user action. To assist in the request, the location related content may include an indication to the user or the content management function 22 that there is a relationship between the currently stored content and additional content available to the mobile telephone 10. In other embodiments, the transmission of updating or replacing content can be automated by sensing the current position of the mobile telephone 10 by the proximity detector(s) 56 and/or the server 46.

In another embodiment, the mobile telephone 10 may give the user an indication that the location related content, or any replacement or update thereto, is available. The user may choose to interact with the content or ignore the content. In this embodiment, the content may be already received and stored by the mobile telephone 10 or simply available for download or reception. In the latter situation, the server 46 can transmit an indication that the location related content is available and, if desired by the user, the user can respond to the indication to obtain the content by transmitting a request for the content using the mobile telephone 10.

Referring to FIG. 9, a time, or temporal-based, method of content management carried out by the mobile telephone 10 is depicted. The method can be embodied as executable code, such as in the form of the content management function 22.

The method can start in block 116 where the mobile telephone 10 receives content associated with a lifespan, or expiration. The content can be location related content as described above or content unassociated with any particular location.

In one embodiment, the lifespan can be defined by a date and time stamp that indicates to the content management function 22 that the content should be deleted when the date and time is after the values set forth in the date and time stamp. In this embodiment, the time at which the content is received may not be related to the lifespan of the content. For example, the content may be a ring tone or audio file containing auld lang syne, which might be useful to the user at the stroke of midnight starting a new year, and the date and time stamp may be set for January 1 st at 1:00 am. When that date and time arrives, it would be appropriate for the content management function 22 to delete the content.

In another embodiment, the lifespan can be a time length stamp that indicates to the content management function 22 that the content should be deleted after a corresponding duration of time from transmission of the content from a transmitting source or from receipt of the content by the mobile telephone 10. For example, the time length stamp may be three hours. Once the content is received and three hours elapses, it would be appropriate for the content management function 22 to delete the content.

The content management function 22 can be configured to delete content having a lifespan defined by either a date and time stamp or a time length stamp, or both. Furthermore, deletion of the content can be carried out after user authorization, if appropriate. A semaphore indicative of whether the content should be deleted automatically at the expiration of the lifespan or with user authorization can be included with the content, thereby providing the source, author or copyright owner of the content with a way to at least in part control the use of the content once transmitted to the mobile telephone 10.

After receipt of the content in block 116, the process can proceed to block 118 where the content is stored in the memory 18. Then, in block 120, the management function 22 determines if the lifespan has expired. If a negative determination is made in block 120, block 120 can repeat until a positive determination is made. Upon a positive determination in block 120, the process can proceed to block 122 where the content is deleted. As indicated, deletion of the content may be automatic or deferred until user authorization.

In one embodiment, if content is received by the mobile telephone 10 that does not have a time-based lifespan, the content management function 22 can assign a lifespan to the content and delete the content after the expiration of the lifespan. The lifespan can be associated with the content automatically and without user authorization, following user authorization or by user initiation.

In yet another embodiment, the temporal lifespan and the location lifespan may be combined. For instance, content could be associated with both a time based deletion scheme and a location based deletion scheme, including any of the time and location deletion schemes described herein. Deletion of the content may be made by the content management function 22 upon the first of the lifespans to expire. Combining the schemes or using multiple lifespans together would enable the content generator to utilize multiple content control techniques.

Accordingly, provided is a system and method of managing the content to conserve memory 18 capacity by preserving content for a limited time and deleting content after the lifespan of the content has expired.

In other embodiments, the user of the mobile telephone 10, through the content management function 22, could have the ability to define content management functions for a selected content item, a selected type of content (e.g., audio, video, data, text, etc.), manner in which the content was acquired (e.g., pushed, pulled, downloaded, etc.) and/or globally for all content. User specified content management functions can be in addition to any content management rules (e.g., time or location based lifespans) associated with the content by the content provider. Content management rules established by the content provider can supersede any rules generated by the user.

The functionality relating the management of content, including, but not limited to, the content management function 22 and corresponding functions of the server 46 and/or proximity detector 56, can be embodied in any suitable form, including software, firmware, dedicated circuit components, computer readable media, machine usable medium and so forth. Further, although the illustrations appended hereto that show a specific order of executing functional logic blocks, the order of execution of the blocks can be changed relative to the order shown. Also, two or more blocks shown in succession can be executed concurrently or with partial concurrence. Certain blocks may also be omitted. In addition, any number of commands, state variables, semaphores, or messages can be added to the logical flow for purposes of enhanced utility, accounting, performance, measurement, or for providing troubleshooting aids, and the like. It is understood that all such variations are within the scope of the present invention.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of managing content in a portable electronic equipment with wireless communication capability and having a memory for storing content, comprising:
receiving content related to a particular location upon positioning of the portable electronic equipment in or near the particular location from a source configured to transmit the location related content as a function of the position of the mobile radio terminal with respect to the location; and
storing the location related content in the memory.

2. The method of claim 1, further comprising deleting the location related content upon departure of the portable electronic equipment from the location.

3. The method of claim 2, wherein the content is deleted automatically upon departure of the portable electronic equipment from the location.

4. The method of claim 2, further comprising detecting the departure from the location.

5. The method of claim 4, wherein the detecting includes sensing a loss of an interface by the portable electronic equipment.

6. The method of claim 4, wherein the detecting includes analyzing relative position data received by the portable electronic equipment.

7. The method of claim 2, further comprising receiving a signal to delete the content from a device external to the portable electronic equipment.

8. The method of claim 2, wherein the deleting includes replacing or updating the content based on movement of the portable electronic equipment to another location.

9. The method of claim 1, wherein the content is push delivered to the portable electronic equipment.

10. The method of claim 1, wherein positioning of the portable electronic equipment in or near the particular location includes at least one of establishing an interface with a proximity detector associated with the particular location or becoming detected by the proximity detector associated with the particular location.

11. The method of claim 1, wherein the portable electronic equipment is a mobile telephone.

12. A method of managing content for a portable electronic equipment with wireless communication capability and having a memory for storing content, comprising:
detecting that the portable electronic equipment is in or near a particular location; and
transmitting content related to the particular location to the portable electronic equipment upon the detecting.

13. The method of claim 12, further comprising detecting the departure of the portable electronic equipment from the particular location and transmitting a signal to the portable electronic equipment to delete the content.

14. The method of claim 13, wherein the detecting includes sensing the loss of an interface with the portable electronic equipment.

15. The method of claim 13, wherein the detecting includes analyzing relative position data related to the portable electronic equipment.

16. The method of claim 12, further comprising determining if the portable electronic equipment is a subscriber for the location related content before transmitting.

17. The method of claim 12, further comprising determining if the portable electronic equipment is configured to accept the location related content before transmitting.

18. The method of claim 12, wherein the detecting includes sensing the establishment of an interface with the portable electronic equipment.

19. The method of claim 12, wherein the detecting includes analyzing relative position data related to the portable electronic equipment.

20. The method of claim 12, wherein the transmitting includes push delivering the location related content to the portable electronic equipment.

21. The method of claim 12, further comprising, before transmitting the content, transmitting an indication that the content is available to the portable electronic equipment and receiving a request from the content from the portable electronic equipment.

22. The method of claim 12, wherein the portable electronic equipment is a mobile telephone.

23. A method of managing content in a portable electronic equipment having wireless communication capability and having a memory for storing content, comprising:
receiving content having a temporal based lifespan;
storing the content in the memory; and
deleting the content upon expiration of the temporal based lifespan.

24. The method of claim 23, wherein the temporal based lifespan is defined by a particular date and time.

25. The method of claim 23, wherein the temporal based lifespan is a length of time from one of transmission of the content from a transmitting source of the content or receipt of the content by the portable electronic equipment.

26. The method of claim 23, further comprising soliciting user authorization to delete the content prior to deleting the content.

27. The method of claim 23, wherein deleting the content is automatic upon expiration of the temporal based lifespan.

28. The method of claim 23, wherein the content is configured for one of automatic deletion upon expiration of the temporal based lifespan or deferring deletion until user authorization is received.

29. A program stored on a machine usable medium, the program including a content management function for a portable electronic equipment with wireless communication capability and having a memory for storing content, comprising executable logic to:
receive content related to a particular location upon positioning of the portable electronic equipment in or near the particular location from a source configured to transmit the location related content as a function of the position of the mobile radio terminal with respect to the location; and
store the location related content in the memory.

30. The program of claim 28, further comprising executable logic to delete the location related content upon departure of the portable electronic equipment from the location.

31. The program of claim 30, wherein the content is deleted automatically upon departure of the portable electronic equipment from the location.

32. The program of claim 30, further comprising executable logic to detect the departure from the location.

33. A program stored on a machine usable medium, the program including a content management function for a portable electronic equipment with wireless communication capability and having a memory for storing content, comprising executable logic to:
detect that the portable electronic equipment is in or near a particular location; and
transmit content related to the particular location to the portable electronic equipment upon the detection.

34. The program of claim 33, further comprising executable logic to detect the departure of the portable electronic equipment from the particular location and transmit a signal to the portable electronic equipment to delete the content.

35. The program of claim 33, further comprising executable logic to determine if the portable electronic equipment is a subscriber for the location related content or configured to accept the location related content before transmission.

36. The program of claim 33, wherein the executable logic to detect includes executable logic to sense the establishment of an interface with the portable electronic equipment.

37. The program of claim 33, wherein the executable logic to detect includes executable logic to analyze relative position data related to the portable electronic equipment.

38. The program of claim 33, wherein the executable logic to transmit includes executable logic to push deliver the location related content to the portable electronic equipment.

39. A program stored on a machine usable medium, the program including a content management function for a portable electronic equipment with wireless communication capability and having a memory for storing content, comprising executable logic to:
receive content having a temporal based lifespan;
store the content in the memory; and
delete the content upon expiration of the temporal based lifespan.

40. The program of claim 39, wherein the temporal based lifespan is defined by a particular date and time.

41. The program of claim 39, wherein the temporal based lifespan is a length of time from one of transmission of the content from a transmitting source of the content or receipt of the content by the portable electronic equipment.

42. The program of claim 39, further comprising executable logic to solicit user authorization to delete the content prior to deleting the content.

43. The program of claim 39, wherein deletion the content is automatic upon expiration of the temporal based lifespan.
